(19) United States
(12) Patent Application Publication
(10) Pub. No.: US 2016/0329539 A1
(43) Pub. Date: Nov. 10, 2016

(54) Lithium Secondary Cell

(71) Applicant: HITACHI, LTD., Tokyo (JP)

(72) Inventors: Jun KAWAJI, Tokyo (JP); Taigo ONODERA, Tokyo (JP)

(21) Appl. No.: 15/111,512

(22) PCT Filed: Feb. 27, 2014
(86) PCT No.: PCT/JP2014/054839

§ 371 Date: Jul. 14, 2016

(51) Int. Cl. H01M 2/16; H01M 10/0565; H01M 4/62; H01M 10/0525

(52) U.S. Cl. CPC H01M 2/168; H01M 10/0525; H01M 10/0565; H01M 4/624; H01M 4/621

(57) ABSTRACT

An object of the present invention is to provide an electrode capable of effectively reducing the resistance in a lithium secondary cell, and a configuration a solid electrolyte layer.

In order to solve this problem, according to the present invention, there is provided a lithium secondary cell including a solid, electrolyte layer provided, between a positive electrode and a negative electrode. A positive electrode mixture layer (40) of the positive electrode includes positive electrode active material particles (42) and solid electrolyte particles (44). A gap between the positive electrode active material particles (42) and the solid electrolyte particles (44) is filled with a Li-conductive binding material, the Li-conductive binding material containing oxide nanoparticles dispersed therein.

### TECHNICAL FIELD

The present invention relates to a lithium secondary cell.

### BACKGROUND ART

A lithium secondary cell using an incombustible or flame retardant solid electrolyte can be highly heat-resistant and safe, and therefore can reduce module cost and can make an energy density high.

As an example of the lithium secondary cell using a solid electrolyte, PTL 1 discloses a cell which includes a solid electrolyte layer in addition to a positive electrode and a negative electrode and in which at least one of the positive electrode, the negative electrode, and the solid electrolyte layer includes a solid electrolyte binder such as a Li—B—O compound.

PTL 2 describes that a resistance of an electrode of a lithium secondary cell is reduced due to an electrode material. obtained by disposing a modified material such as TiO₂ in a contact interface between an electrode active material containing a tetravalent element such as LiMn₂O₄ and a solid electrolyte material containing a tetravalent element different from the element in the electrode active material, such as Li_{1.5}Al_{0.5}Ge_{1.5}(PO)₃.

Meanwhile, PTL 3 discloses a structure in which a binder containing polyvinylidene fluoride in a negative electrode active material layer is complexed with nano ceramic particles of 100 nm or less, such as SiO₂ or TiO₂, in order to improve input-output characteristics of a non-aqueous lithium secondary cell containing an electrolytic solution.

### CITATION LIST

### Patent Literature

PTL 1: JP 2013-084377 A

PTL 2: JP 2013-149433 A

PTL 3: JP 2009-206092 A

### SUMMARY OF INVENTION

### Technical Problem

In PTLs 1 to 3, it is difficult to reduce a resistance in an electrode of a lithium secondary cell.

That is, in PTL 1, the ion conductivity of a binder such as Li₃BO₃ is insufficient, and there is room for improving an electrode resistance.

In PTL 2, Li conduction in an interface is promoted by disposing a modified material in a contact interface between an electrode active material and a solid electrolyte material. However, when an electrolyte used (for example, Li_{1.5}Al_{0.5}Ge_{1.5}(PO)₃) is crystalline, the electrolyte is not easily softened, and is not easily deformed even in a glass state. Therefore, it is difficult to increase a contact interface between the electrolyte and a particulate electrode active material, resulting in causing increase in an electrode resistance.

In PTL 3, Li conduction in a negative electrode impregnated with an electrolytic solution is promoted. However, when application to a solid cell is considered, a binder itself to be complexed with nano ceramic particles, such as polyvinylidene fluoride, has no Li conductivity, and therefore a resistance in an electrode cannot be reduced

In view of these circumstances, an object of the present invention is to provide structures of an electrode and a sol id electrolyte layer capable of reducing a resistance in a lithium secondary cell effectively.

### Solution to Problem

In order to solve the above problem, a lithium secondary cell of the present invention is provided with solid electrolyte layer between a positive electrode and a negative electrode, and at least one of the positive electrode, the negative electrode, and the solid electrolyte layer contains active material particles and/or solid electrolyte particles. In at least one of the positive electrode, the negative electrode, and the solid electrolyte layer, a gap between the active material particles and/or a gap between the solid electrolyte particles are/is filled with a Li conductive binding material formed of a Li-containing oxide. Oxide nanoparticles are dispersed in the Li conductive binding material.

### Advantageous Effects of Invention

The present invention can enhance ion conductivity of a binding material with which a gap between active material particles and a gap between solid electrolyte particles are filled, and can improve charge-discharge characteristics of a lithium secondary cell. Problems, structures, and effects other than the above will be revealed by the following description of embodiments.

### BRIEF DESCRIPTION OF DRAWINGS

FIG. 1 is a cross sectional view of a lithium secondary cell according to an embodiment of the present invention.

FIG. 2 is a cross sectional view of a main part of the lithium secondary cell according to the embodiment of the present invention.

FIG. 3 is a cross sectional view of a main part of the lithium secondary cell according to the embodiment of the present invention.

FIG. 4 is a schematic diagram for describing main part of the lithium secondary cell according to the embodiment of the present invention.

FIG. 5 is a diagram illustrating an X-ray diffraction measurement result of a Li conductive binding material having oxide nanoparticles dispersed in Example 1.

FIG. 6 is a diagram illustrating charge-discharge curves of lithium secondary cells in Example 1 and Comparative Example 1.

FIG. 7 is a cross sectional view of a main part of a conventional lithium secondary cell.

FIG. 8 is a cross sectional view of a main part of a conventional lithium secondary cell.

### DESCRIPTION OF EMBODIMENTS

Hereinafter, embodiments of the present invention will be described with reference to the drawings or the like.

The following description indicates specific examples of the present invention. The present invention is not limited to the description, but can be changed or modified variously by a person skilled in the art within a scope of a technical idea disclosed here. In the drawings for describing the present invention, the same reference sign is given to components having the same function, and repeated description thereof may be omitted.

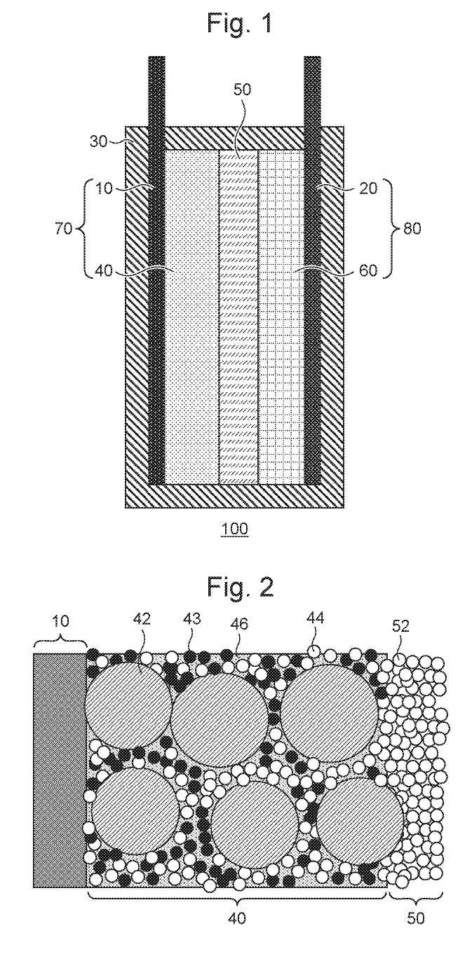

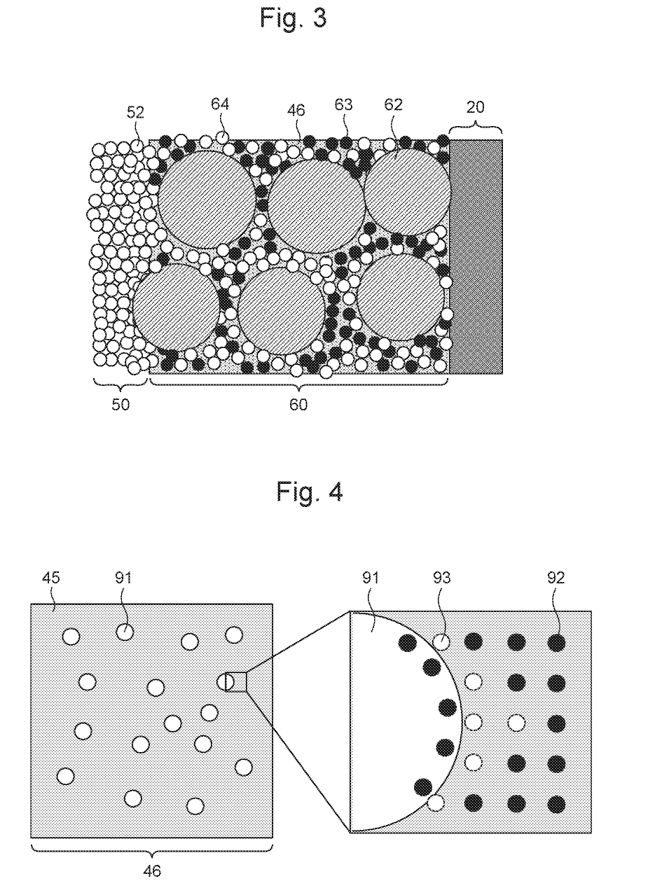

FIG. 1 is a cross sectional view of a lithium secondary cell according to an embodiment of the present invention. Each of FIGS. 2 and 3 is a cross sectional view of a main part of the lithium secondary cell according to the embodiment of the present invention. As illustrated in FIG. 1, a lithium secondary cell 100 of the present invention includes a positive electrode 70, a negative electrode 80, a cell case 30, and a solid electrolyte layer 50. The positive electrode 70 is formed of a positive electrode current collector 10 and a positive electrode mixture layer 40. The negative electrode 80 is formed of a negative electrode current collector 20 and a negative electrode mixture layer 60.

<Positive Electrode Current Collector>

The positive electrode current collector 10 is electrically connected to the positive electrode mixture layer 40. Examples of the positive electrode current collector 10 include an aluminum foil having a thickness of 10 μm to 100 μm, an aluminum perforated foil having a thickness of 10 μm to 100 μm and a pore diameter of 0.1 mm to 10 mm, expanded metal, and a foamed metal plate. In addition to aluminum, a material such as stainless steel or titanium can be applied. In the present invention, any positive electrode current collector can be used without being limited by a material, a shape, a manufacturing method, or the like.

<Negative Electrode Current Collector>

The negative electrode current collector 20 is electrically connected to the negative electrode mixture layer 60. Examples of the negative electrode current collector 20 include a copper foil having a thickness of 10 μm to 100 μm, a copper perforated foil having a thickness of 10 μm to 100 μm and a pore diameter of 0.1 mm to 10 mm, expanded metal, and a foamed metal plate. In addition to copper, a material such as stainless steel, titanium, or nickel can be applied. In the present invention, any negative electrode current collector can be used without being limited by a material, a shape, manufacturing method, or the like.

<Cell Case>

The cell case 30 accommodates the positive electrode current collector 10, the negative electrode current collector 20, the positive electrode mixture layer 40, the solid electrolyte layer 50, and the negative electrode mixture layer 60. The shape of the cell case 30 can be appropriately selected from a cylindrical shape, a flat ellipse shape, a flat oval shape, a rectangular shape, and the like according to a shape of an electrode group formed of the positive electrode mixture layer 40, the solid electrolyte layer 50, and the negative electrode mixture layer 60. A material of the cell case 30 can be selected from materials having corrosion resistance with respect to a non-aqueous electrolyte such as aluminum, stainless steel, or nickel-plated steel.

<Positive Electrode Mixture Layer>

The positive electrode mixture layer 40 includes positive electrode active material particles 42, an optional positive electrode conductive agent 43, optional solid electrolyte particles 44, and an optional positive electrode binder.

Examples of the positive electrode active material particles 42 include LiCoO₂, LiNiO₂, LiMn₂O₄, LiMnO₃, LiMn₂O₃, LiMnO₂, Li₄Mn₅O₁₂, LiMn₂₋ₓMₓO₂ (M is at least one selected from the group consisting of Co, Ni, Fe, Cr, Zn, and Ti, and x=0.01 to 0.2), Li₂Mn₃MO₈ (M is at least one selected from the group consisting of Fe, Co, Ni, Cu, and Zn), Li₁₋ₓAₓMn₂O₄ (A is at least one selected from the group consisting of Mg, B, Al, Fe, Co, Ni, Cr, Zn, and Ca, and x=0.01 to 0.1), LiNi₁₋ₓMₓO₂ (M is at least one selected from the group consisting of Co, Fe, and Ga, and x=0.01 to 0.2), LiFeO₂, Fe₂(SO₄)₃, LiCo₁₋ₓMₓO₂ (M is at least one selected from the group consisting of Ni, Fe, and Mn, and x=0.01 to 0.2), LiNi₁₋ₓMₓO₂ (M is at least one selected from the group consisting of Mn, Fe, Co, Al, Ga, Ca, and Mg, and x=0.01 to 0.2), Fe(MoO₄)₃, FeF₃, LiFePO₄, and LiMnPO₄. The above materials may be included singly or in a mixture of two or more kinds thereof. A lithium ion is released from the positive electrode active material particles 42 in a charge process, and a lithium ion released from negative electrode active material particles in the negative electrode mixture layer 60 is inserted thereinto in a discharge process.

The particle diameter of each of the positive electrode active material particles 42 is usually defined so as to be the thickness of the positive electrode mixture layer 40 or less. When coarse particles having a size of the thickness of the positive electrode mixture layer 40 or more are included as positive electrode active material particles, positive electrode active material particles having a size of the thickness of the positive electrode mixture layer 40 or less are preferably prepared by removing the coarse particles by sieve classification, wind flow classification, or the like in advance.

The positive electrode active material particles 42 generally have a high electrical resistance due to being formed of an oxide-based material, and therefore the positive electrode conductive agent 43 is used for supplementing electrical conductivity. Examples of the positive electrode conductive agent 43 include a carbon material such as acetylene black, carbon black, graphite, or amorphous carbon. Alternatively, it is possible to use oxide particles exhibiting electronic conductivity, such as indium-tin oxide (ITO) or antimony-tin oxide (ATO).

The positive electrode active material particles 42 and the positive electrode conductive agent 43 are usually powder. Therefore, when a Li conductive binding material having oxide nanoparticles dispersed 46 as described below is not used for filling, it is preferable to bind the powder particles together by mixing a binder having a binding ability with the powder, and simultaneously to bond the powder to the positive electrode current collector 10. Examples of the positive electrode binder include styrene-butadiene rubber, carboxymethyl cellulose, polyvinylidene fluoride (PVDF), and a mixture thereof.

The positive electrode 70 can be manufactured by attaching a positive electrode slurry obtained by mixing the positive electrode active material particles 42, the positive electrode conductive agent 43, a positive electrode binder, and an organic solvent to the positive electrode current collector 10 by a doctor blade method, a dipping method, a spraying method, or the like, then drying the organic solvent, and molding the resulting product under pressure by roll pressing. By performing the process of application to drying a plurality of times, a plurality of the positive electrode mixture layers 40 can be laminated on the positive electrode current collector 10.

<Negative Electrode Mixture Layer>

The negative electrode mixture layer 60 includes negative electrode active material particles 62, an optional negative electrode conductive agent 63, optional solid electrolyte particles 64, and an optional negative electrode binder.

Examples of the negative electrode active material particles 62 include a carbon material capable of inserting and releasing a lithium ion reversibly, Si and SiO as a silicon-based material, lithium titanate in which some of the elements are substituted or unsubstituted, a lithium vanadium composite oxide, and an alloy of lithium with a metal such as tin, aluminum, antimony, or the like. Examples of the carbon material include natural graphite, a composite carbon-based material obtained by forming a coating film on natural graphite by a dry CVD method or a wet spraying method, a resin material such as an epoxy resin or a phenol resin, artificial graphite manufactured by calcination using a pitch-based material obtained from petroleum or coal as a raw material, and a non-graphitizable carbon material. As the negative electrode active material particles 62, the above materials may be used singly or in a mixture of two or more kinds thereof. In the negative electrode active material particles 62, an insertion-release reaction of a lithium ion or a conversion reaction proceeds in a charge-discharge process.

The particle diameter of each of the negative electrode active material particles 62 is usually defined so as to be the thickness of the negative electrode mixture layer 60 or less. When the negative electrode active material particles 62 include coarse particles having a size of the thickness of the negative electrode mixture layer 60 or more, particles having a size of the thickness of the negative electrode mixture layer 60 or less are preferably prepared by removing the coarse particles by sieve classification, wind flow classification, or the like in advance.

Examples of the negative electrode conductive agent 63 include a carbon material such as acetylene black, carbon black, graphite, or amorphous carbon.

The negative electrode active material particles 62 and the negative electrode conductive agent 63 are usually powder. Therefore, when the Li conductive binding material having oxide nanoparticles dispersed 46 as described below is not used for filling, it is preferable to bind the powder particles together by mixing a binder having a binding ability with the powder, and simultaneously to bond the powder to the negative electrode current collector 20. Examples of the negative electrode binder include styrene-butadiene rubber, carboxymethyl cellulose, polyvinylidene fluoride (PVDF), and a mixture thereof.

The negative electrode 80 can be manufactured by attaching a negative electrode slurry obtained by mixing the negative electrode active material particles 62, the negative electrode conductive agent 63, a negative electrode binder, and an organic solvent to the negative electrode current collector 20 by a doctor blade method, a dipping method, a spraying method, or the like, then drying the organic solvent, and molding the resulting product under pressure by roll pressing. By performing the process of application to drying a plurality of times, a plurality of the negative electrode mixture layer 60 can be laminated on the negative electrode current collector 20.

<Solid Electrolyte Layer>

As illustrated in FIGS. 2 and 3, the solid electrolyte layer 50 includes solid electrolyte particles 52 and a binder for binding the solid electrolyte particles 52, if necessary. Alternatively, a polymer electrolyte film having Li conductivity can be used as the solid electrolyte layer 50.

The layer thickness of the solid electrolyte layer 50 is preferably from 1 μm to 1 mm. The layer thickness is preferably 10 μm to 50 μm, and particularly preferably from 10 μm to 30 μm from a viewpoint of ion conductivity and strength. The layer thickness of less than 1 μm cannot maintain the strength sufficiently. The layer thickness of more than 1 mm increases a conduction resistance of an ion, and reduces an energy density in a cell.

The solid electrolyte layer 50 is disposed between the positive electrode 70 and the negative electrode 80 in a sheet form. In order to increase a contact area with an electrode, it is preferable to dispose unevenness having a size of 1 μm to 100 μm and formed artificially on a surface.

The surface roughness of the solid electrolyte layer 50 preferably has an arithmetic mean roughness Ra of 0.1 μm to 5 μm. A larger roughness is more preferable from a viewpoint of adhesion to an electrode. When the roughness is smaller than 0.1 μm, the contact area with the electrode is small, and an interface resistance is increased.

The solid electrolyte particles 52 are not particularly limited as long as being a solid material conducting a lithium ion, but desirably contain an incombustible inorganic solid electrolyte from a viewpoint of safety. A similar material can be used for the optional solid electrolyte particles 44 in the positive electrode mixture layer 40 and the optional solid electrolyte particles 64 in the negative electrode mixture layer 60. Examples thereof include an oxide-based solid electrolyte such as a perovskite type oxide, a NASICON type oxide, a LISICON type oxide, or a garnet-type oxide, a sulfide-based solid electrolyte, and β alumina. Examples of the perovskite type oxide include a Li—La—Ti-based perovskite type oxide represented by LiₐLa₁₋ₐTiO₃, a Li—La—Ta-based perovskite type oxide represented by Li_{b}La_{1-b}TaO₃, and a Li—La—Nb-based perovskite type oxide represented by Li_{c}La_{1-c}NbO₃ (in the formulae, 0<a<1, 0<b<1, 0<c<1). Examples of the NASICON type oxide include an oxide represented by LiₘXₙYₒPₚO_{q} having a crystal such as Li₁₊₁Al₁Ti₂₋₁(PO₄)₃ as a main crystal (in the formulae, X is at least one element selected from the group consisting of B, Al, Ga, In, C, Si, Ge, Sn, Sb, and Se, Y is at least one element selected from the group consisting of Ti, Zr, Ge, In, Ga, Sn, and Al, 0≦1≦1, and each of m, n, o, p, and q is any positive number). Examples of the LISICON type oxide include an oxide represented by Li₄XO₄—Li₃YO₄ (in the formula, X is at least one element selected from the group consisting of Si, Ge, and Ti, and Y is at least one element selected from the group consisting of P, As, and V). Examples of the garnet-type oxide include a Li—La—Zr-based oxide such as Li₇La₃Zr₂O₁₂. Examples of the sulfide-based solid electrolyte include, Li₂S—P₂S₅, Li₂S—SiS₂, Li_{3.25}P_{3.25}Ge_{0.76}S₄, Li₄₋ᵣGe₁₋ᵣPᵣS₄ (in the formula, 0≦r ≦1), Li₇P₃S₁₁, and Li₂S—SiS₂—Li₃PO₄. The sulfide-based solid electrolyte may be either a crystalline sulfide or an amorphous a sulfide. These solid electrolyte particles may be used singly or in combination of two or more kinds thereof.

The particle diameter of each of fixed electrolyte particles 52 is preferably from 0.01 μm to 10 μm. A particle diameter of more than 10 μm easily generates a gap between the particles. When the particle diameter is smaller than 0.01 μm, it may be difficult to compress the particles in a step for forming the solid electrolyte layer 50.

The ion conductivity of the solid electrolyte particles 52 is preferably 1×10⁻⁶ S/cm or more, and more preferably 1×10⁻⁴ S/cm or more. When the ion conductivity of the solid electrolyte particles 52 is 1×10⁻⁶ S/cm or more, a resistance in a cell can be kept low by using a Li conductive binding material 45 described below together. This ion conductivity is a value at 25° C.

The porosity of the solid electrolyte layer 50 is preferably from 0 to 10%. The porosity is more preferably from 0 to 5% from a viewpoint of the ion conductivity.

A polymer electrolyte film having Li conductivity can be used as the solid electrolyte layer 50. In this case, an ether bond-containing polymer such as polyethylene oxide (PEO) can be used as a material thereof. A polymer having a solid solution of a Li salt such as LiPF₆, LiBF₄, LiFSI, or LiTFSI therein can be used.

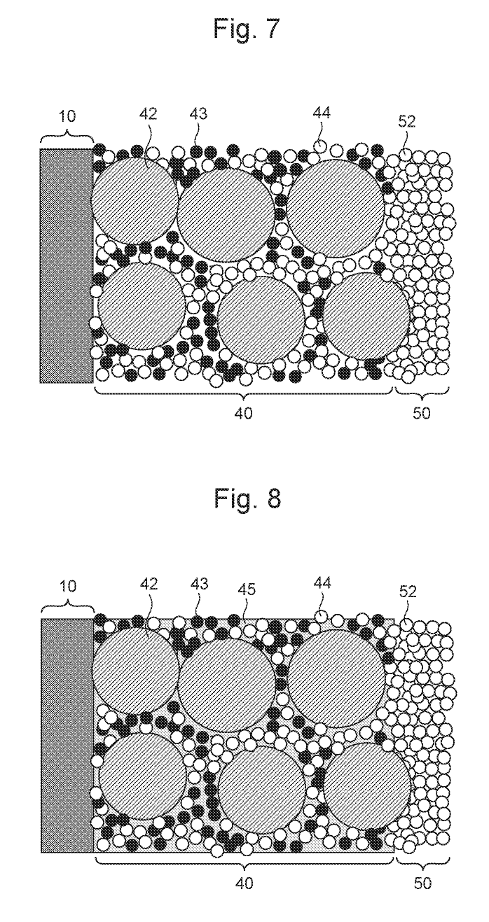

FIGS. 2, 7, and 8 illustrate enlarged views of an electrolyte layer and a positive electrode. FIGS. 7 and 8 illustrate a structure of a conventional electrode. An example in which the structure of the present invention is applied to the positive electrode 70 will be described below. However, a similar structure can be used for the solid electrolyte layer 50 and the negative electrode 80.

In FIG. 7, the positive electrode mixture layer 40 does not include a material for filling a gap between the positive electrode active material particles 42 or a gap between the solid electrolyte particles 44. The ion conduction between a positive electrode active material particle and a positive electrode active material particle or between a positive electrode active material particle and a solid electrolyte particle is limited to contact points. Meanwhile, in FIG. 8, the gap between the positive electrode active material particles 42 and the gap between the solid electrolyte particles 44 are filled with the Li conductive binding material 45. This Li conductive binding material 45 has the same function as the above positive electrode binder in terms of presence between particles, but is largely different therefrom in terms of having Li conductivity.

FIG. 2 is an enlarged view of a solid electrolyte layer and a positive electrode of the lithium secondary cell according to the embodiment of the present invention. The gap between the electrode active material particles 42 and the gap between the solid electrolyte particles 44 are filled with the Li conductive binding material having oxide nanoparticles dispersed 46. The present invention is the same as the example in FIG. 8 in terms of using a Li conductive binding material, but is largely different therefrom in terms of containing oxide nanoparticles in the Li conductive binding material. Use of such a structure improves Li conductivity in an electrode, and reduces a resistance of the entire electrode, resulting in improvement of charge-discharge characteristics of a cell.

A reason why the above effect is obtained will be described below with reference to the drawings. FIG. 4 is an enlarged view in the Li conductive binding material having oxide nanoparticles dispersed 46, and the Li conductive binding material 46 is formed of the Li conductive binding material 45 and oxide nanoparticles 91. FIG. 4 also illustrates a schematic diagram of an interface between the Li conductive binding material 45 and the oxide nanoparticles 91. The oxide nanoparticles 91 have a Li occlusion ability. Some of Li ions 92 present in the Li conductive binding material 45 move to the oxide nanoparticles 91 in the interface between the Li conductive binding material 45 and the oxide nanoparticles 91. A region which has occluded Li is formed on a side of the oxide nanoparticles 91 (on a surface of the oxide nanoparticles 91), and a Li depletion region 93 is formed on a side of the Li conductive binding material 45. It is considered that this Li depletion region 93 becomes a Li ion conduction path, ion conduction of the entire Li conductive binding material 45 is promoted, and charge-discharge characteristics of a cell are improved.

<Oxide Nanoparticles>

The oxide nanoparticles 91 used in the present invention need to have a lithium occlusion ability, and are desirably formed of an oxide containing any one of Ti, Sn, and Si. These oxide nanoparticles can be a lithium oxide containing Li—Sn, Li—Sn, or Li—Si by occluding lithium on a surface thereof. Specific examples thereof include TiO₂ having a rutile structure or an anatase structure, SnO, SnO₂, SiO₂, and SiO. These oxide nanoparticles may be chemically changed after occluding Li, and may be dispersed in the Li conductive binding material 45 as LiTiO₂, Li₂TiO₃, LiSnO₂, Li₂SnO₃, Li₂SiO₃, or the like. Among these oxide nanoparticles, particularly by using TiO₂ having a relatively small change in volume when occluding Li (which can be TiO₂ containing lithium on a surface thereof while being dispersed), the ion conductivity in an electrode can be enhanced most efficiently.

Furthermore, as the oxide nanoparticles 91 used in the present invention, a transition metal-phosphorus oxide can be used. Specific examples thereof include CoPO₄, NiPO₄, and FePO₄. These particles may be dispersed in the Li conductive binding material 45 as LiCoPO₄, LiNiPO₄, or LiFePO₄ by occluding Li. These phosphorus acid compounds have a high lithium occlusion ability, and are effective for reducing a resistance of a cell.

The particle diameter of each of the oxide nanoparticles 91 is desirably from 1 nm to 100 nm, and particularly desirably from 5 nm to 100 nm from a viewpoint of reducing a resistance in a cell. The particle diameter is more desirably from 10 nm to 30 nm. A particle diameter of less than 1 nm is not effective because oxide nanoparticles and a Li conductive binding material are mixed uniformly in an atomic level, and the Li depletion region 93 as illustrated in FIG. 4 is not formed, particle diameter of more than 100 nm reduces an area of an interface between oxide nanoparticles and a Li conductive binding material, and the oxide nanoparticles do not easily enter a gap between active material particles or a gap between solid electrolyte particles, resulting in increase in a resistance in a cell. The particle diameter here means a particle diameter of a primary particle. In fact, not only primary particles are dispersed alone, but also the primary particles are agglomerated to form secondary particles in some cases. However, the effect of the present invention is exhibited even in these cases. The particle diameter can be measured by disassembling a cell and measuring the particle diameter by a BET method or a particle size distribution meter, or by directly observing the inside of the cell with a transmission electron microscope (TEM) or a scanning electron microscope (SEM). Actual oxide nanoparticles do not have a single particle diameter but have a particle size distribution in many cases. In these cases, the particle diameter is a median diameter. Here, the median diameter is also referred to as D50, and means a diameter at which the particle number on a side of a larger particle diameter is equal to that on a side of a smaller particle diameter when powder is divided into two at a boundary of a certain particle diameter.

An addition amount of the oxide nanoparticles 91 can be set appropriately within a range capable of obtaining the effect of the present invention. Specifically, when a volume fraction of the oxide nanoparticles 91 occupied in a composite of the Li conductive binding material having oxide nanoparticles dispersed 46 is 5% or more and 40% or less, the effect is easily obtained. The volume fraction is more desirably 5% or more and 20% or less. An addition amount of less than 5% reduces an effect for forming a Li depletion region. An addition amount of more than 40% reduces a volume fraction of the Li conductive binding material 45 as a Li conduction path, and as a result, a resistance in a cell may be increased. Here, the volume fraction of the oxide nanoparticles 91 can be measured actually by microstructure observation, or can be calculated based on densities of the Li conductive binding material 45 and the oxide nanoparticles 91 and charged amounts thereof.

<Li Conductive Binding Material>

The Li conductive binding material 45 used in the present invention is not particularly limited as long as a material can be filled into a gap formed between active material particles or a gap formed between solid electrolyte particles, and has Li conductivity. A particularly desirable material can be divided into a “material softened and fluidized by heating” and a “material softened and fluidized by being dissolved in a solvent”.

The “material softened and fluidized by heating” desirably has a melting point of 700° C. or lower. When a material having a melting point of higher than 700° C. is used, it is necessary to expose an electrode to a high temperature atmosphere in order to fluidize a binding material, and active material particles, solid electrolyte particles, a current collector, or the like may be changed in quality. Particularly, the melting point is more desirably 650° C. or lower. This is because a laminate of mixture layers or solid electrolyte layers on an aluminum foil widely used as a positive electrode current collector can be directly heated when the melting point is lower than the melting point (660° C.) of the aluminum foil.

Examples of the “material softened and fluidized by heating” include a Li-containing oxide. Specific examples thereof include Li₃BO₃ and Li₃₋ₓCₓB₁₋ₓO₃ (0<x<1). These melting points are from 680° C. to 700° C. A material obtained by dispersing oxide nanoparticles in these materials reduces the melting point. For example, a material obtained by dispersing TiO₂ nanoparticles in Li₃BO₃ has a melting point of 630° C. A factor therefor is not clear, but Li may be removed from Li₃BO₃ to form Li₄B₂O₅ with change in a crystal structure. It is considered that this is because a Li conductive binding material formed of a Li₃BO₃—Li₄B₂O₅ phase having a low melting point is formed as a result.

Specific examples of the “material softened and fluidized by being dissolved in a solvent” include a Li-containing oxide having deliquescency. The Li-containing oxide having deliquescency is a binding material which conducts an ion as a carrier for performing a cell reaction and has deliquescency. In the present invention, having deliquescency means having a property of deliquescence in a normal temperature range (5° C. or higher and 35° C. or lower) in the atmosphere. By using a Li-containing oxide having deliquescency for manufacturing at least one of a positive electrode, a negative electrode, and a solid electrolyte layer, it is possible to form a matrix-like structure in which a gap between active material particles and/or a gap between solid electrolyte particles (active material particles or solid electrolyte particles form the electrode or the solid electrolyte layer) are/is filled with a Li-containing oxide at a high density. By filling the Li conductive binding material formed of a Li-containing oxide into the gap at a high density, a Li conduction path is enlarged, and a resistance in a cell can be reduced. Specific examples of the Li-containing oxide having deliquescency include lithium metavanadate (LiVO₃) and lithium-vanadium oxide including LiVO₃.

By adding oxide nanoparticles having a Li occlusion ability to such a Li conductive binding material as described above, Li moves to the oxide nanoparticles, and a Li depletion region is formed on a side of the Li conductive binding material. Here, the Li depletion region includes a region in which only a Li ion is deficient and a hole is formed while a crystal structure is maintained, and also includes a region in which a crystal structure has been changed with elimination of another element after the hole is formed. In the above Li conductive binding material mainly containing Li₃BO₃, in addition to Li₃₋ₓBO₃ in which a Li hole is formed, even a region including a crystal phase such as Li₄B₂O₅, Li₆B₄O₉, LiBO₂, Li₂B₄O₇, or Li₂B₈O₁₃ obtained by change in a crystal structure can be considered to be a Li depletion region. Also in the Li conductive binding material mainly containing LiVO₃, in addition to Li₁₋ₓVO₃, V₂O₅ can be considered to be a Li depletion region.

The ion conductivity of the Li conductive binding material 45 is preferably 1×10⁻⁹ S/cm or more, and more preferably 1×10⁻⁷ S/cm or more. By an ion conductivity of 1×10⁻⁹ S/cm or more, ion conductivity between active material particles and active material particles or between active material particles and solid electrolyte particles can be improved significantly, an internal resistance of a lithium secondary cell can be reduced well, and a higher discharge capacity can be secured. This ion conductivity is a value at 25° C.

Here, a method for manufacturing the lithium secondary cell having the structure in FIGS. 2 and 4 will be exemplified, but the lithium secondary cell can be manufactured by a method other than this method.

When a material melted, softened and fluidized by heating is used as a Li conductive binding material, the positive electrode 70 can be manufactured through i) a step for mixing at least powder of the positive electrode active material particles 42 and the Li conductive binding material 45 with the oxide nanoparticles 91 to prepare an electrode paste, ii) a step for applying the electrode paste on the positive electrode current collector 10, and iii) a step for heating the electrode paste to the melting point of the Li conductive binding material having oxide nanoparticles dispersed 46 to soften and fluidize the electrode paste.

In i), powder of the positive electrode active material particles 42 and the Li conductive binding material 45, and the oxide nanoparticles 91 are blended in predetermined amounts, and are mixed using an agate mortar or a ball mill. The solid electrolyte particles 44 or the positive electrode conductive agent 43 may be added thereto, if necessary. Furthermore, by mixing the above mixture with a non-conductive resin such as an ethyl cellulose solution (solvent: butyl carbitol acetate) as a positive electrode binder, an electrode paste can be obtained. In ii), an electrode paste is applied on a positive electrode current collector by a blade coater method, a screen printing method, a die coater method, a spray coating method, or the like, and the positive electrode mixture layer 40 can be formed into a thin film. After application, the coating film can be pressed, if necessary. In iii), by heating the coating film and decomposing and removing the positive electrode binder used in i), and then holding the coating film at the melting point of the Li conductive binding material having oxide nanoparticles dispersed 46 or higher, a gap between particles can be filled with a melted binding material. In this heating step, Li movement is promoted between the oxide nanoparticles 91 and the Li conductive binding material 45, and a state in FIG. 4 is formed.

When a material softened and fluidized by being dissolved in a solvent is used as the Li conductive binding material 45, the positive electrode 70 can be manufactured through i) a step for mixing at least powder of the positive electrode active material particles 42 and the Li conductive binding material 45 with the oxide nanoparticles 91, ii) a step for adding a solvent in which the Li conductive binding material 45 is dissolved to obtain an electrode paste, iii) a step for applying the electrode paste on the positive electrode current collector 10, and iv) a step for drying the solvent by heating. In i), powder of the positive electrode active material particles 42 and the Li conductive binding material 45, and the oxide nanoparticles 91 are blended in predetermined amounts, and are mixed using an agate mortar or a ball mill. The solid electrolyte particles 44 or the positive electrode conductive agent 43 may be added thereto, if necessary. In ii), a solvent in which the Li conductive binding material 45 can be dissolved to form a paste is added. When the deliquescent LiVO₃ material is used, a polar solvent containing water can be used as a solvent. In iii), the electrode paste is applied on the positive electrode current collector 10 by a blade coater method, a screen printing method, a die coater method, a spray coating method, or the like, and the electrode paste can be formed into a thin film. After application, the coating film can be pressed, if necessary. In iv), heating is performed at a temperature at which the solvent used for the electrode paste can be removed. In this heating step, Li movement is promoted between the oxide nanoparticles 91 and the Li conductive binding material 45, and such a state as in FIG. 4 is formed.

Hereinabove, the method for manufacturing the positive electrode 70 has been described. However, this method can be applied similarly to a case where the negative electrode 80 or the solid electrolyte layer 50 is manufactured. That is, the negative electrode 80 or the solid electrolyte layer 50 can be formed, for example, by preparing a paste by mixing the Li conductive binding material 45 and the oxide nanoparticles 91 with at least the negative electrode active material particles 62, the solid electrolyte particles 52, or the like, and then applying the paste on a substrate such as a current collector.

Whether a lithium secondary cell is the lithium secondary cell of the present invention can be determined by disassembling the lithium secondary cell, observing a cross section thereof with SEM or TEM, and analyzing a composition thereof by energy dispersive X-ray spectroscopy (EDX), electron energy loss spectroscopy (EELS), or the like. Whether a Li depletion region is formed around an interface between a Li conductive binding material and oxide nanoparticles can be determined by analyzing a crystal structure in the disassembled sample by X-ray diffractometry (XRD).

As described above, in the present invention, a gap between active material particles or a gap between solid electrolyte particles (active material particles or solid electrolyte particles form at least one layer of a positive electrode, a negative electrode, and a solid electrolyte layer) is filled with a Li conductive binding material formed of a Li-containing oxide, and oxide nanoparticles are dispersed in the binding material. Ion conduction of the Li conductive binding material is thereby promoted, as a result, a resistance of an entire cell is reduced, and a lithium secondary cell having excellent charge-discharge characteristics can be obtained.

### EXAMPLES

Hereinafter, the present invention will be described in more detail with Examples and Comparative Examples, but is not limited only to Examples disclosed here. The present Examples indicate only a case where the structure of the present invention is applied to a positive electrode, but a similar effect can be obtained even when the structure of the present invention is applied to a negative electrode or a solid electrolyte layer.

(Synthesis of Li₃BO₃ Binding Material)

11.41 g of lithium carbonate Li₂CO₃ and 3.58 g of boron oxide B₂O₃ were blended together, and were mixed with a planetary ball mill using zirconia balls. After mixing, the mixed powder was put into an alumina crucible, and was heated at 600° C. for 24 hours. A crystal structure of the resulting powder was analyzed by XRD, and as a result, it was confirmed that the powder was Li₃BO₃. This powder was used as a Li₃BO₃ binding material. The melting point thereof was measured by differential thermal analysis (DTA), and was found to be 690° C. The density thereof was 2.4 g/cm³.

(Synthesis of Li—C—B—O Binding Material)

12.96 g of lithium carbonate Li₂CO₃ and 2.03 g of boron oxide B₂O₃ were blended together, and were mixed with a planetary ball mill using zirconia balls. After mixing, the mixed powder was put into an alumina crucible, and was heated at 600° C. for 24 hours. The resulting powder was subjected to elemental analysis, and was confirmed to be Li_{2.4}C_{0.6}B_{0.4}O₃. A crystal structure of Li was analyzed by XRD, and as a result, an XRD pattern close to Li₂CO₃ was obtained. It was confirmed that a crystal peak was shifted to a wide angle side. This powder was used as a Li—C—B—O binding material. The melting point thereof was measured by differential thermal analysis (DTA), and was found to be 695° C.

(Synthesis of LiVO₃ Binding Material)

First, 1.85 g of lithium carbonate (Li₂CO₃) and 4.55 g of divanadium pentoxide (V₂O₅) were weighed and put into a mortar, and were mixed until becoming uniform. Subsequently, the resulting mixture was put into an alumina crucible having an outer diameter of 60 mm, and was heated in a box-shaped electric furnace. In this heat treatment, the temperature was raised at a temperature rise rate of 10° C./min to 580° C. in the atmosphere, and then the temperature was maintained at 580° C. for ten hours. After the heat treatment, the mixture was cooled to 100° C. to obtain lithium metavanadate (LiVO₃) as a Li conductive binding material having deliquescency.

(Manufacturing Solid Electrolyte Paste)

To 0.85 g of Li₇La₃Zr₂O₁₂ (hereinafter, referred to as LLZO) having an average particle diameter of 1.5 μm, 0.15 g of the Li₃BO₃ binding material was added, and 0.5 g of a 5% by weight ethyl cellulose solution (solvent: butyl carbitol acetate) was added as a resin binder to manufacture a solid electrolyte paste.

### Comparative Example 1

In the present Comparative Example, a lithium secondary cell containing Li₃BO₃ as a Li conductive binding material in a positive electrode was manufactured.

(1-1) To 1.5 g of LiCoO₂ powder having an average particle diameter of 10 μm, 0.5 g of Li₃BO₃ powder was added. The resulting mixture was put into a mortar and was mixed. Thereafter, 1.5 g of a 5% by weight ethyl cellulose solution was added thereto, and the resulting mixture was kneaded to prepare a positive electrode paste.

(1-2) The kneaded positive electrode paste was screen-applied on an Au foil having a diameter of 10 mm.

(1-3) The solvent was dried at 150° C., and then cold pressing was performed by hand press.

(1-4) The sample was put on an alumina plate, and was heated at 700° C. to decompose and remove ethyl cellulose, and Li₃BO₃ was melted. After cooling, a weight was measured. As a result, the coating amount was 3 mg/cm² as a weight of LiCoO₂ per cm² of an electrode.

(1-5) A side surface of the positive electrode obtained in (1-4) above was masked with an insulator. Subsequently, a polyethylene oxide (PEO) film (thickness: 50 μm) containing lithium bistrifluoro methanesulfonyl imide ((CF₃SO₂)₂NLi, (LiFSI)) as a lithium salt was laminated on a side of a solid electrolyte layer, and a lithium foil as a negative electrode was laminated. The resulting laminate was incorporated into a CR2025 type coin cell.

### Comparative Example 2

In the present Comparative Example, a lithium secondary cell containing Li—B—C—O as a Li conductive binding material in a positive electrode was manufactured.

(2-1) The lithium secondary cell in Comparative Example 2 was manufactured in a similar manner to Comparative Example 1 except that Li₃BO₃ added to the positive electrode paste in Comparative Example 1 was replaced with Li—B—C—O.

### Comparative Example 3

In the present Comparative Example, a lithium secondary cell containing LiVO₃ as a Li conductive binding material in a positive electrode was manufactured.

(3-1) To 1.5 g of LiCoO₂ powder having an average particle diameter of 10 μm, 0.5 g of LiVO₃ powder was added. The resulting mixture was put into a mortar and was mixed. Thereafter, 0.1 g of water was added thereto for deliquescence of LiVO₃. Furthermore, the viscosity was adjusted with N-methyl 2-pyrrolidon to manufacture a positive electrode paste containing a deliquescent binding material.

(3-2) The positive electrode paste obtained in (3-1) above was applied on an aluminum foil current collector, and was heated at 120° C. for 30 minutes to remove water. Thereafter, the resulting product was punched in a disk shape having a cross-sectional area of 1 cm² to obtain a positive electrode.

(3-3) A side surface of the positive electrode obtained in (3-2) above was masked with an insulator. Subsequently, a polyethylene oxide (PEO) film (thickness: 50 μm) containing lithium bistrifluoro methanesulfonyl imide ((CF₃SO₂)²NLi, (LiFSI)) as a lithium salt was laminated on a side of a solid electrolyte layer, and a lithium foil as a negative electrode was laminated. The resulting laminate was incorporated into a CR2025 type coin cell. The resulting product was used as Comparative Example 3.

### Example 1

In the present Example, a lithium, secondary cell having oxide nanoparticles containing a Ti oxide dispersed in a Li conductive binding material Li₃BO₃ in a positive electrode was manufactured. A charging weight ratio the oxide nanoparticles with respect to the Li conductive binding material was 10% (about 5.8% in terms of a volume fraction), and a heat treatment temperature was the same as that in Comparative Example 1. The volume fraction was calculated by using a density of 2.4 g/cm³ of Li₃BO₃ and a density of 3.9 g/cm³ of TiO₂ nanoparticles.

(4-1) To 1.5 g of LiCoO₂ powder having an average particle diameter of 10 μm, 0.5 g of Li₃BO₃ powder was added. 0.05 g of anatase type TiO₂ particles (manufactured by Aldrich Corporation, primary particle diameter: 20 nm to 30 nm, specific gravity: 3.9 g/cm³) was put into a mortar, and was mixed with the powder. Thereafter, 1.5 g of a 5% by weight ethyl cellulose solution was added thereto, and the resulting mixture was kneaded to prepare a positive electrode paste.

(4-2) The positive electrode paste prepared in (4-1) above was screen-applied on an Au foil having a diameter of 10 mm.

(4-3) The solvent was dried at 150° C., and then cold pressing was performed by hand press.

(4-4) The sample was put on an alumina plate, and was heated at 700° C. to decompose and remove ethyl cellulose, and Li₃BO₃ was melted. After cooling, a weight was measured. As a result, the coating amount was 3 mg/cm² as a weight of LiCoO₂ per cm² of an electrode.

(4-5) The lithium secondary cell in Example 1 was obtained in a similar manner to Comparative Example 1 except that the positive electrode obtained in (4-4) above was used.

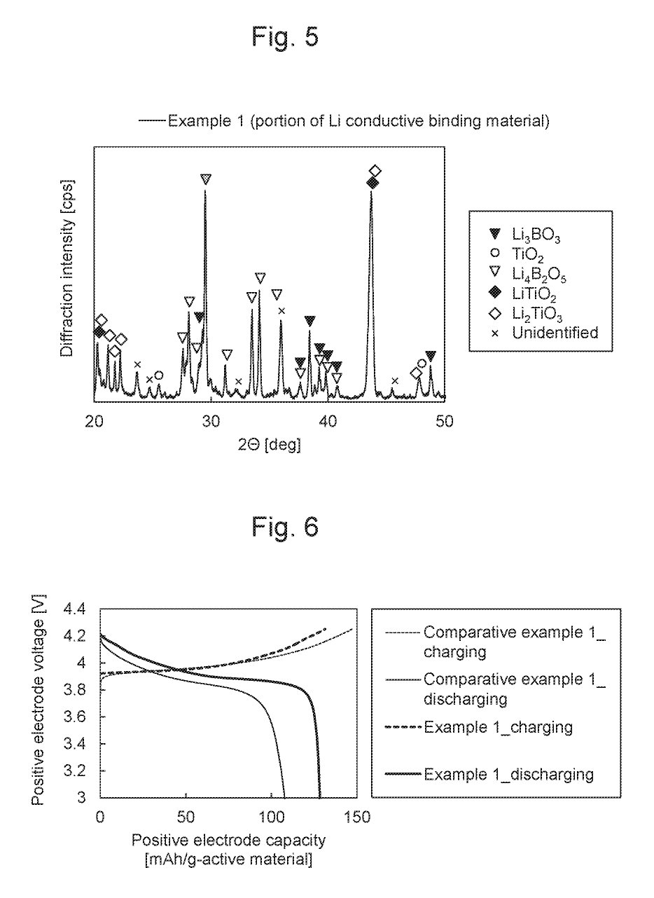

(4-6) In (4-1) above, a paste formed of Li₃BO₃ and TiO₂ was prepared without adding LiCoO₂. A sample obtained by applying a Li conductive binding material having oxide nanoparticles dispersed on an Au foil was prepared in a similar manner to (4-2) to (4-4), and was structurally analyzed by X-ray diffractometry (CU-Kα ray) Results thereof are illustrated in FIG. 5. As illustrated in FIG. 5, it has been revealed that Li₄B₂O₅ in which a Li depletion region is formed by release of Li from Li₃BO₃, or a LiTiO₂ or Li₂TiO₃ phase formed by doping of TiO₂ with Li is formed in addition to Li₃BO₃ and TiO₂.

### Example 2

In the present Example, a lithium secondary cell having oxide nanoparticles containing a Ti oxide dispersed in a Li conductive binding material Li₃BO₃ in a positive electrode and having a heat treatment temperature lowered to 650° C. during manufacturing the positive electrode was manufactured.

(5-1) The lithium secondary cell in Example 2 was manufactured in a similar manner to Example 1 except that the heat treatment temperature of the positive electrode in Example 1 was changed from 700° C. to 650° C.

### Example 3

In the present Example, a lithium secondary cell having oxide nanoparticles containing a Ti oxide dispersed in a Li conductive binding material Li₃BO₃ in a positive electrode and having a charging weight ratio of the oxide nanoparticles with respect to the Li conductive binding material of 25% (about 13.3% in terms of a volume fraction) was manufactured.

(6-1) The lithium secondary cell in Example 3 was manufactured in a similar manner to Example 2 except that the addition amount of TiO₂ particles added to the positive electrode paste in Example 2 was 0.125 g.

### Example 4

In the present Example, a lithium secondary cell having oxide nanoparticles containing a Ti oxide dispersed in a Li conductive binding material Li₃BO₃ in a positive electrode and having a charging weight ratio of the oxide nanoparticles with respect to the Li conductive binding material of 40% (about 19.8% in terms of a volume fraction) was manufactured.

(7-1) The lithium secondary cell in Example 4 was manufactured in a similar manner to Example 2 except that the addition amount of TiO₂ particles added to the positive electrode paste in Example 2 was 0.2 g.

### Example 5

In the present Example, a lithium secondary cell having oxide nanoparticles containing a Ti oxide dispersed in a Li conductive binding material Li₃BO₃ in a positive electrode and having a charging weight ratio of the oxide nanoparticles with respect to the Li conductive binding material of 50% (about 23.5% in terms of a volume fraction) was manufactured.

(8-1) The lithium secondary cell in Example 5 was manufactured in a similar manner to Example 2 except that the addition amount of TiO₂ particles added to the positive electrode paste in Example 2 was 0.25 g.

### Example 6

In the present Example, a lithium secondary cell having oxide nanoparticles containing a Ti oxide dispersed in a Li conductive binding material Li—C—B—O in a positive electrode was manufactured.

(9-1) The lithium secondary cell in Example 6 was manufactured in a similar manner to Comparative Example 2 except that the amount of TiO₂ particles added to the positive electrode paste in Comparative Example 2 was 0.125 g.

### Example 7

In the present Example, a lithium secondary cell having oxide nanoparticles containing a Ti oxide dispersed in a Li conductive binding material LiVO₃ in a positive electrode was manufactured.

(10-1) The lithium secondary cell in Example 7 was manufactured in a similar manner to Comparative Example 3 except that the amount of TiO₂ particles added to the positive electrode paste in Comparative Example 3 was 0.125 g.

### Example 8

In the present Example, a lithium secondary cell having oxide nanoparticles containing a Si oxide dispersed in a Li conductive binding material Li₃BO₃ in a positive electrode and having a charging weight ratio of the oxide nanoparticles with respect to the Li conductive binding material of 13% (about 12.4% in terms of a volume fraction) was manufactured.

(11-1) The lithium secondary cell in Example 8 was manufactured in a similar manner to Example 2 except that 0.125 g of SiO₂ particles (particle diameter: about 30 nm, specific gravity: 2.2 g/cm³) was added to the positive electrode paste in place of TiO₂ particles in Example 2.

### Example 9

In the present Example, a lithium secondary cell having oxide nanoparticles containing a Sn oxide dispersed in a Li conductive binding material Li₃BO₃ in a positive electrode and having a charging weight ratio of the oxide nanoparticles with respect to the Li conductive binding material of 40% (about. 12.4% in terms of a volume fraction) was manufactured.

(12-1) The lithium secondary cell in Example 9 was manufactured in a similar manner to Example 2 except that 0.125 g of SnO₂ particles (particle diameter: about 30 nm, specific gravity: 6.9 g/cm³) was added to the positive electrode paste in place of TiO₂ particles in Example 2.

### Example 10

In the present Example, a lithium secondary cell having oxide nanoparticles containing FePO₄ oxide dispersed in a Li conductive binding material Li₃BO₃ in a positive electrode and having a charging weight ratio of the oxide nanoparticles with respect to the Li conductive binding material of 25% (about 14.0% in terms of a volume fraction) was manufactured.

(13-1) Li was released from LiFePO₄ particles having a primary particle diameter of 50 nm by a chemical treatment to obtain oxide nanoparticles formed of FePO₄.

(13-2) The lithium secondary cell in Example 10 was manufactured in a similar manner to Example 2 except that 0.125 g of FePO₄ particles manufactured in (13-1) was added to the positive electrode paste in place of TiO₂ particles in Example 2.

(Evaluation of Lithium Secondary Cell)

The manufactured coin type lithium secondary cells in Comparative Examples 1 to 3 and Examples 1 to 10 were charged at a rate of 0.02 C (10 μA/cm²) using a 1480 potentiostat manufactured by Solartron Corporation, then was held at SOC=100% for one hour, and an AC resistance thereof was evaluated with an AC impedance device. The AC resistance was fitted with an appropriate equivalent circuit, and a positive electrode resistance was evaluated separately. Thereafter, the cells were discharged at a rate of 0.02 C (10 μA/cm²). An upper limit potential was 4.25 V, and a lower limit potential was 3 V. A charge capacity and a discharge capacity were measured, and a ratio therebetween was used as an initial coulombic efficiency. In Comparative Example 1 and Example 1, charging and discharging were repeated at the same rate, and a retention ratio of the discharge capacity was evaluated.

Table 1 indicates a charge-discharge capacity, an initial coulombic efficiency, and a positive electrode resistance in each of Comparative Examples 1 to 3 and Examples 1 to 10. FIG. 6 illustrates charge-discharge curves in Example 1 and Comparative Example 1.

TABLE 1

| | | | charging | heat | initial | initial | initial | positive |
|---|---|---|---|---|---|---|---|---|
| | | oxide | weight | treatment | charge | discharge | coulombic | electrode |
| | Li conductive | nano- | ratio | temperature | capacity | capacity | efficiency | resistance |
| sample | binding material | particles | [%] | [° C.] | [mAh/g] | [mAh/g] | [%] | [kΩcm²] |
| Comparative | Li₃BO₃ | — | — | 700 | 150 | 109 | 73 | 1.5 |
| Example 1 | | | | | | | | |
| Comparative | Li—C—B—O | — | — | 700 | 160 | 111 | 69 | 1.4 |
| Example 2 | | | | | | | | |
| Comparative | LiVO₃ | — | — | 120 | 160 | 111 | 69 | 0.6 |
| Example 3 | | | | | | | | |
| Example 1 | Li₃BO₃ | TiO₂ | 10 | 700 | 150 | 130 | 87 | 1.0 |
| Example 2 | Li₃BO₃ | TiO₂ | 10 | 650 | 135 | 132 | 98 | 0.8 |
| Example 3 | Li₃BO₃ | TiO₂ | 25 | 650 | 142 | 138 | 97 | 0.7 |
| Example 4 | Li₃BO₃ | TiO₂ | 40 | 650 | 150 | 145 | 97 | 0.5 |
| Example 5 | Li₃BO₃ | TiO₂ | 50 | 650 | 150 | 125 | 83 | 1.1 |
| Example 6 | Li—C—B—O | TiO₂ | 25 | 700 | 155 | 150 | 97 | 0.8 |
| Example 7 | LiVO₃ | TiO₂ | 25 | 120 | 153 | 149 | 97 | 0.5 |
| Example 8 | Li₃BO₃ | SiO₂ | 13 | 650 | 136 | 135 | 99 | 0.8 |
| Example 9 | Li₃BO₃ | SnO₂ | 40 | 650 | 135 | 131 | 97 | 0.8 |
| Example 10 | Li₃BO₃ | FePO₄ | 25 | 650 | 151 | 149 | 99 | 0.5 |

(Discussion of Results)

Comparison between Comparative Example 1 and Example 1 indicates that a discharge capacity and a charge-discharge efficiency are improved by adding oxide nanoparticles formed of TiO₂ in a positive electrode using the same Li conductive binding material (Li₃BO₃). Here, an ion conductivity of a pellet-like Li conductive binding material single substance was measured, and the ion conductivity of the single substance was 10⁻¹¹ S/cm or less. However, it has been revealed that the ion conductivity is improved to 1×10⁻⁹ S/cm by adding 10% by weight of TiO₂. It is considered that the improvement of the ion conductivity is a primary factor for improving charge-discharge characteristics. These cells were subjected to a charge-discharge cycle test. It has been thereby found that the capacity is reduced to 60% of the initial capacity in the third cycle in Comparative Example 1 but 90% of the discharge capacity is maintained even after 10 cycles in Example 1. This indicates that improvement of the ion conductivity of a Li conductive binding material makes reversible charging and discharging in an electrode smooth. By XRD analysis and TEM-EELS analysis of the Li conductive binding material having oxide nanoparticles dispersed, a phase which had occluded Li (LiTiO₂), a phase which had occluded Li and had further changed a structure thereof (Li₂TiO₃), or the like was observed on a surface of the oxide nanoparticles. A Li depletion region of Li₄B₂ O₅ or the like was observed in the Li conductive binding material around an interface in contact with the oxide nanoparticles. It is considered that movement of Li between the oxide nanoparticles and the Li conductive binding material and formation of the Li depletion region in accordance therewith contributed to improvement of the ion conductivity.

Comparison between Examples 1 and 2 indicates that any one of the discharge capacity, the coulombic efficiency, and the positive electrode resistance is better in Example 2. Li₃BO₃ to which TiO₂ has been added has a melting point of 630° C. Even when the heat treatment temperature was lowered from 700° C. in Example 1 to 650° C. in Example 2, an effect of adding TiO₂ was exhibited sufficiently. It is considered that performance was improved by suppression of a side reaction between active material particles and the Li conductive binding material due to lowering the heat treatment temperature. An element distribution between the active material particles and the Li conductive binding material in an electrode was observed by TEM-EELS. A Co₃O₄ phase was slightly confirmed on a particle surface of the active material (LiCoO₂) in Example 1. Meanwhile, it was confirmed that the Co₃O₄ phase could be suppressed in Example 2.

In Examples 2 to 5, the addition amount of TiO₂ with respect to the Li conductive binding material was changed. It has been found that the discharge capacity and the resistance are improved with increase in a weight ratio of TiO₂ with respect to the Li conductive binding material (volume fraction of TiO₂ with respect to the Li conductive binding material including TiO₂) to 10% by weight (5.8% by volume), 25% by weight (13.3% by volume), and 40% by weight (19.8% by volume). However, it has been found that the resistance is increased by increase in the weight ratio of TiO₂ to 50% by weight (23.5% by volume). It can be understood that this is because the contact area between the oxide nanoparticles and the Li conductive binding material is increased by increase in the addition amount to a certain amount, and the Li conductivity is improved, but excess increase in the addition amount reduces the volume of the Li conductive binding material as a Li conduction path. From the above, it has been found that, in the present invention, the addition amount of the oxide nanoparticles is more desirably 5% or more and 20% or less in terms of a volume fraction occupied in a composite of the oxide nanoparticles and the Li conductive binding material.

In Comparative Example 2 and Example 6 or Comparative Example 3 and Example 7, a TiO₂ addition effect with respect to the lithium secondary cell using Li—C—B—O or LiVO₃ as a Li conductive binding material was evaluated. From the comparison, it has been confirmed that the discharge capacity and the coulombic efficiency are improved and the resistance is reduced by adding oxide nanoparticles formed of TiO₂ even when Li—C—B—O or LiVO₃ is used as a Li conductive binding material. Particularly use of LiVO₃ allows an electrode utilizing deliquescency thereof to be formed, and allows the heat treatment temperature to be low. Therefore, a desirable lithium secondary cell can be manufactured without thermally damaging a cell component such as active material particles, a solid electrolyte, or a current collector.

In Examples 8, 9, and 10, SiO₂, SnO₂, or FePO₄ was used as oxide nanoparticles added, and any one of the discharge capacity, the coulombic efficiency, and the resistance was better than those in Comparative Example 1. It has been revealed that oxide nanoparticles have occluded Li by XRD or TEM-EELS analysis of an electrode. From the above, it has been found that even a case where particles other than TiO₂ particles are used as oxide nanoparticles is effective for improving performance of a lithium secondary cell.

As described above, it has been revealed that charge-discharge characteristics of a positive electrode are largely improved by filling a Li conductive binding material formed of a Li-containing oxide into a gap between active material particles forming the positive electrode and dispersing oxide nanoparticles in the binding material.

In Examples above, solid electrolyte particles or a conductive agent is not added to a positive electrode. However, in a positive electrode having these added, a similar effect is obtained.

Even when the structure of the present invention is applied to an inside of a negative electrode or a solid electrolyte layer, the Li conductivity of a Li conductive binding material is improved, and as a result, a lithium secondary cell having excellent charge-discharge characteristics can be obtained. Industrial applicability

By connecting a lithium secondary cell obtained in the present invention to a cell controller or a control panel and protecting the lithium secondary cell with a housing, the lithium secondary cell can be utilized as a storage device. This storage device can be disposed in a front or a bottom of a vehicle body as a power source for an automobile. In addition, the storage device can be used as an industrial power source for demand-supply balance of electric power.

### REFERENCE SIGNS LIST

10 positive electrode current collector
20 negative electrode current collector
30 cell case
40 positive electrode mixture layer
42 positive electrode active material particles
43 positive electrode conductive agent
44 solid electrolyte particles
45 Li conductive binding material
46 Li conductive binding material having oxide nanoparticles dispersed
50 solid electrolyte layer
52 solid electrolyte particles
60 negative electrode mixture layer
62 negative electrode active material particles
63 negative electrode conductive agent
64 solid electrolyte particles
70 positive electrode
80 negative electrode
91 oxide nanoparticles
92 Li ion
93 Li depletion region
100 lithium secondary cell

All of the publications, patents, and patent applications cited here are incorporated herein as it is as a reference.

1. A lithium secondary cell, wherein
a solid electrolyte layer is disposed between a positive electrode and a negative electrode,
at least one of the positive electrode, the negative electrode, and the solid electrolyte layer contains one or both of active material particles and solid electrolyte particles,
in at least one of the positive electrode, the negative electrode, and the solid electrolyte layer, one or both of a gap between the active material particles and a gap between the solid electrolyte particles are filled with a Li conductive binding material formed of a Li-containing oxide, and
oxide nanoparticles are dispersed in the Li conductive binding material.

2. The lithium secondary cell according to claim 1, wherein
a region which has occluded Li is formed on a side of the oxide nanoparticles, and a Li depletion region is formed on a side of the Li conductive binding material in an interface between the Li conductive binding material and the oxide nanoparticles.

3. The lithium secondary cell according to claim 1, wherein
the oxide nanoparticles are formed of one or more selected from TiO₂, SnO, SnO₂, SiO₂, SiO, CoPO₄, NiPO₄, and FePO₄.

4. The lithium secondary cell according to claim 2, wherein
the oxide nanoparticles are formed of one or more selected from TiO₂, SnO, SnO₂, SiO₂, SiO, CoPO₄, NiPO₄, and FePO₄, and contain lithium on a surface thereof.

5. The lithium secondary cell according to claim 1, wherein
a volume fraction of the oxide nanoparticles occupied in the Li conductive binding material having the oxide nanoparticles dispersed is 5% or more and 20% or less.

6. The lithium secondary cell according to claim 1, wherein
the Li conductive binding material is formed of a Li-containing oxide softened and fluidized by heating, and has a melting point of 700° C. or lower.

7. The lithium secondary cell according to claim 6, wherein
the Li conductive binding material is formed of Li₃BO₃ or Li₃₋ₓCₓB₁₋ₓO₃ (0<x<1).

8. The lithium secondary cell according to claim 1, wherein
the Li conductive binding material is formed of a Li-containing oxide softened and fluidized by being dissolved in a solvent.

9. The lithium secondary cell according to claim 8, wherein the Li conductive binding material is formed of LiVO₃.

10. A storage device including the lithium secondary cell according to claim 1.
